(19) United States
(12) Patent Application Publication
(10) Pub. No.: US 2015/0052079 A1
(43) Pub. Date: Feb. 19, 2015

(54) PROVIDING AN INDEX AND PORTFOLIO WITH DEFINED ACTIVE SHARE LEVEL

(71) Applicant: KANIA RESEARCH LTD, London (GB)

(72) Inventor: Witold Witkiewicz, London (GB)

(21) Appl. No.: 14/460,678

(22) Filed: Aug. 15, 2014

Related U.S. Application Data
(60) Provisional application No. 61/867,066, filed on Aug. 17, 2013.
(60) Provisional application No. 61/903,425, filed on Nov. 13, 2013.
(60) Provisional application No. 61/921,607, filed on Dec. 30, 2013.

(51) Int. Cl. G06Q 40/06

(52) U.S. Cl. CPC G06Q 40/06
USPC 705/36 R

(57) ABSTRACT

A current portfolio comprising financial objects and a current benchmark comprising a subset of the financial objects of the current portfolio are selected. For each unique financial object of the current portfolio and benchmark, an active weight of the corresponding financial object is computed and a current aggregate active weight is derived based on the computed active weight. A primary benchmark is selected, and segments of interest are identified. A segmented benchmark is computed. Then, an intermediate portfolio is computed based on the segmented benchmark and the current aggregate active weight. For each financial object, an intermediate active weight is computed, and for each segment of the intermediate portfolio, an active share of the corresponding segment of the intermediate portfolio is computed. A required active share level is selected. For each segment of the intermediate portfolio, a scaling factor is computed, and a segmented final portfolio including segments is created.

### CROSS REFERENCE TO RELATED APPLICATIONS

This application claims the benefit of U.S. Provisional Patent Application Ser. No. 61/867,066, filed Aug. 17, 2013, entitled METHODS AND SYSTEMS FOR PROVIDING AN ACTIVE PORTFOLIO WITH DEFINED ACTIVE SHARE LEVEL; U.S. Provisional Patent Application Ser. No. 61/903,425, filed Nov. 13, 2013, entitled METHODS AND SYSTEMS FOR PROVIDING AN INDEX AND PORTFOLIO WITH DEFINED ACTIVE SHARE LEVEL; and U.S. Provisional Patent Application Ser. No. 61/921,607, filed Dec. 30, 2013 entitled METHODS AND SYSTEMS FOR PROVIDING AN INDEX AND PORTFOLIO WITH DEFINED ACTIVE SHARE LEVEL, the disclosures of which are hereby incorporated by reference.

### BACKGROUND

The present disclosure pertains generally to technological aspects of securities, and more particularly to improvements in technological fields utilized to create a portfolio with a defined active share.

Securities investment management is generally categorized as passive management or active management. The aim of passive management is to realize an investment performance and profile which closely replicates the performance and profile of a benchmark, such as a financial index. For instance, in passive management, securities in a portfolio may fully (or nearly fully) duplicate those securities that are included in the benchmark. Statistical modeling techniques may also be used to create a portfolio that duplicates the profile, risk characteristics, performance characteristics, and securities weightings of the benchmark, without actually owning every security included in the benchmark.

The aim of active management is to realize an investment performance which outperforms the benchmark. In order to achieve this, by definition actively managed portfolio security holdings must be different from the benchmark. Thus, in active management, the securities are selected for a portfolio individually. The selection of securities may be based on qualitative and quantitative analysis of economic, financial, business information and conditions; on technical trends; on economic, financial and business patterns; etc.

Reference to active management thus refers to any strategy and product that aims to deviate from a benchmark in order to realize excess return and/or offer an enhancement in risk/return profile. Portfolio holdings can differ from the benchmark holdings because of stock selection, or factor timing, or both. Stock selection involves selecting individual securities and their weightings in a combination which is expected to contribute to outperformance. Factor timing involves time-varying bets on systematic risk factors relative to the benchmark.

Conventionally, the degree of stock selection is measured by active share, which measures the proportion of the portfolio that differs from its benchmark. For traditional long-only portfolios, active share is defined as the sum of the absolute values of active weights divided by two (active weight is the difference between the weight of a security in a portfolio and the weight of that security in the portfolio's benchmark). For alternative portfolios, active share is adjusted taking also into account short selling and leverage, whereas the degree of factor timing is measured by tracking error which represents the volatility of the difference between a portfolio return and its benchmark return.

Active share thus provides information about the potential for a securities portfolio to outperform its benchmark; this follows from the fact that outperformance can only be generated by portfolio securities holdings being different from its benchmark. Also, as the expense ratio for active management is often higher compared to passive management, investors may prefer an active management portfolio to differ sufficiently and consistently from its benchmark so that the potential for generating outperformance is not negatively affected or otherwise limited.

By construction, about 50% of the value of a benchmark, for instance a financial index, experiences above-average returns and about 50% experiences below-average returns relative to the benchmark itself. Hence, by definition securities portfolio holdings that correspond to more than 50% of benchmark holdings, i.e., an active share of less than 50%, include holdings which cannot be expected to outperform the benchmark and that have a negative expected alpha. Here, alpha is a measure of risk-adjusted excess return relative to a benchmark. Hence, an active share of 50% is the theoretical minimum that active management could possibly have.

### BRIEF SUMMARY

According to aspects of the present disclosure, a method comprises selecting a current portfolio comprising financial objects. The method also comprises selecting a current benchmark comprising a subset of the financial objects of the current portfolio. The method further comprises computing, for each unique financial object of the current portfolio and current benchmark, an active weight of the corresponding financial object. Here, the active weight indicates how much the corresponding financial object differs in contributing to the current portfolio, and in contributing to the current benchmark. Also, the method comprises deriving, for each unique financial object of the current portfolio and current benchmark, a current aggregate active weight based on the computed active weight. The method still further comprises selecting a primary benchmark including financial objects, identifying segments of interest including a number of segments of interest, and computing a segmented benchmark based on the segments of interest and the primary benchmark.

The method yet further comprises computing an intermediate portfolio based on the segmented benchmark and the current aggregate active weight. In this regard, the intermediate portfolio comprises segments of the financial objects of the current aggregate active weight. The method also comprises computing, for each financial object of the intermediate portfolio, an intermediate active weight, and computing, for each segment of the intermediate portfolio, an active share of the corresponding segment of the intermediate portfolio. The method yet further comprises selecting a required active share level, and computing a required segmented active share based on the required active share level and the segments of interest.

The method still further comprises computing, for each segment of the intermediate portfolio, a scaling factor based on the required active share level and the intermediate active share of the corresponding segment of the intermediate portfolio. The method also comprises computing a scaled portfolio based on the intermediate active weights and the scaling factors. Also, the method comprises creating a segmented final portfolio including segments based on the scaled portfolio such that an active share of each of the segments of the segmented final portfolio is generally equal to the required segmented active share for that segment.

In an illustrative example, the identified segments of interest may further comprise proportions of the segments of interest within the segmented final portfolio. Here, the required segmented active share is computed based on the required active share level and the segments of interest, including the proportions.

### BRIEF DESCRIPTION OF THE SEVERAL VIEWS OF THE DRAWINGS

FIG. 1 illustrates a schematic diagram of a system and computer-readable medium provided in accordance with aspects of the present disclosure;

FIGS. 2A-2B are a flow chart depicting an illustrative embodiment of a process for providing an index and portfolio with defined active share level in accordance with aspects of the present disclosure;

FIGS. 3A-3C are a flow chart depicting another embodiment of a process for providing an index and portfolio with defined active share level in accordance with aspects of the present disclosure;

FIGS. 4A-4B are a flow chart illustrating a method of creating a portfolio with a segmented active share, according to further aspects of the present disclosure; and

FIG. 5 is a flow chart illustrating a method of iterating intermediate portfolios to produce a segmented final portfolio with a segmented active share, according to yet further aspects of the present disclosure.

### DETAILED DESCRIPTION

Various embodiments of the disclosure are discussed in detail below by way of example. While specific implementations are discussed, it should be understood that this is done for illustration purposes only. A person skilled in the relevant art can recognize that other components and configurations may be used without parting from the spirit and scope of the disclosure.

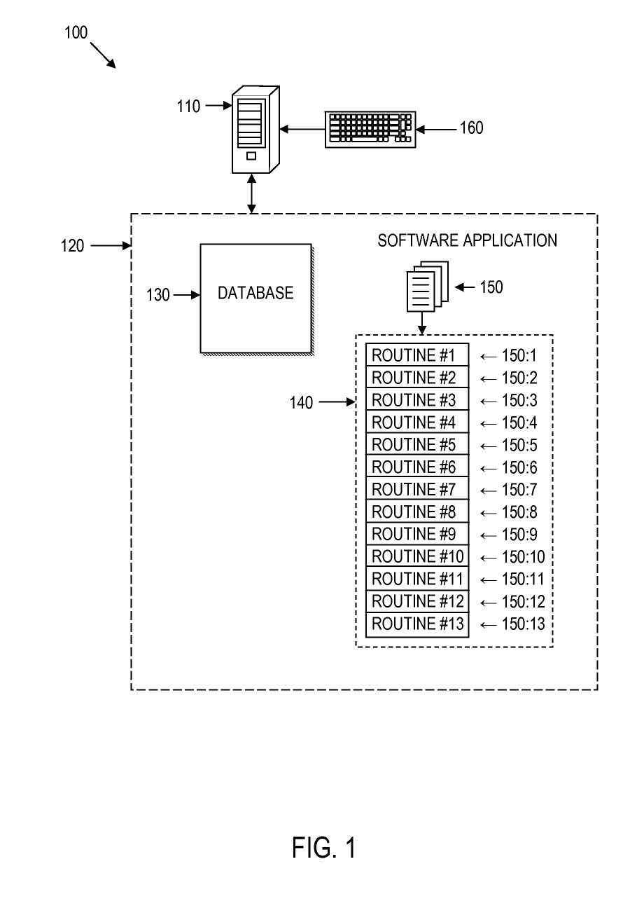

Referring now to the drawings and in particular to FIG. 1, an illustrative embodiment of a suitable computer-based structure is schematically illustrated. The computer-based structure is suitable to implement a process for generating an index and portfolio with defined active share level. A computing system 100 comprises at least a processor 110 and a memory 120. Memory 120 stores both database 130 and a computer software application 140. Computer software application 140 comprises a plurality of instruction routines 150, which are executed by the processor 110 to carry out particular steps in the methods of the presently described disclosure, including the claimed methods and the methods and processes defined by the remaining FIGURES herein. The processor 110 may be contained within a single computer system such as system 100, or distributed among multiple computer systems. Likewise, database 130 may be contained within a single computer system such as system 100, or distributed among multiple computer systems. Data may be manually entered into database 130 in various ways; for example (1) via a keyboard 160, which is operatively connected to processor 110, (2) downloaded from an internet server (not shown), or (3) transferred from a local storage medium (not shown), such as a removable flash memory device. The data which is input to and stored in the database 130 may include:
the identity of the at least one first group of financial objects;
any characteristic about the at least one first group of financial objects;
the identity of each of the plurality of financial objects from the at least one first group of financial objects;
any characteristic about each of the plurality of financial objects from the at least one first group of financial objects;
a measure which determines the magnitude of each of the plurality of financial objects from the at least one first group of financial objects (including a measure assigned to each of the plurality of financial objects by converting a non-numerical scale into numerical value using whatever criteria is considered suitable);
the identity of benchmark(s);
any characteristic about the benchmark(s);
the identity of each of the plurality of financial objects comprising the benchmark(s);
any characteristic about each of the plurality of financial objects comprising the benchmark(s);
a measure which determines the magnitude of each of the plurality financial object comprising the benchmark(s);
calendar date(s) to which any aspect of the collected information relates; and
any combination of the above.
   The above list is not intended to be exhaustive and other data may also and/or alternatively be input to and stored in the database 130.

In various illustrative embodiments, a financial object may include:
a financial instrument and/or security, e.g., debt, equity, a hybrid, etc.;
an asset and/or liability;
a portfolio of financial instruments and/or securities, e.g., a fund, an investment entity, an exchange traded note and/or exchange traded fund;
a financial index;
a commodity;
any financial derivative based on any of the above;
a plurality of any of these;
more broadly any sort of investment.
   The above list is not intended to be exhaustive of all types of financial objects.

In various illustrative embodiments, a benchmark may include:
a financial instrument and/or security, e.g., debt, equity, a hybrid, etc.;
an asset and/or liability;
a portfolio of financial instruments and/or securities, e.g., a fund, an investment entity, an exchange traded note and/or exchange traded fund;
a financial index;
a commodity;
any financial derivative based on any of the above;
a plurality of any of these;
   The above list is not intended to be exhaustive of all types of benchmarks. Rather, a benchmark may comprise more broadly, any financial object(s) in any composition and/or structure used as standard against which the performance, characteristics and/or composition of financial object(s) and/or investment(s) can be measured and compared.

In an illustrative embodiment, portfolio holdings (financial objects) of several open-ended equity funds (e.g., a first group of financial objects) can be stored in the database 130. A data entry person can key-in the data using keyboard 160, i.e., data entered by the keyboard 160 is obtained by the processor 110 and is loaded into the database 130. Alternatively, the data may be downloaded into the database 130 from another server or memory, or from a feed stream directly transmitted from a provider. Also, data regarding constituents comprising one or several benchmarks can be obtained and stored in the database 130 in a similar way.

The database 130 can also store information identifying each open-ended equity fund, and each portfolio holding in each open-ended equity fund, such as the name and/or symbol of each open-ended equity fund. The database 130 can further store information identifying a name and/or symbol of each portfolio holding in each open-ended equity fund, and one or more measures of magnitude of each portfolio holding in each open-ended equity fund, e.g., monetary value and/or percentage of overall holdings. Moreover, the database 130 can store similar information regarding a benchmark or several benchmarks.

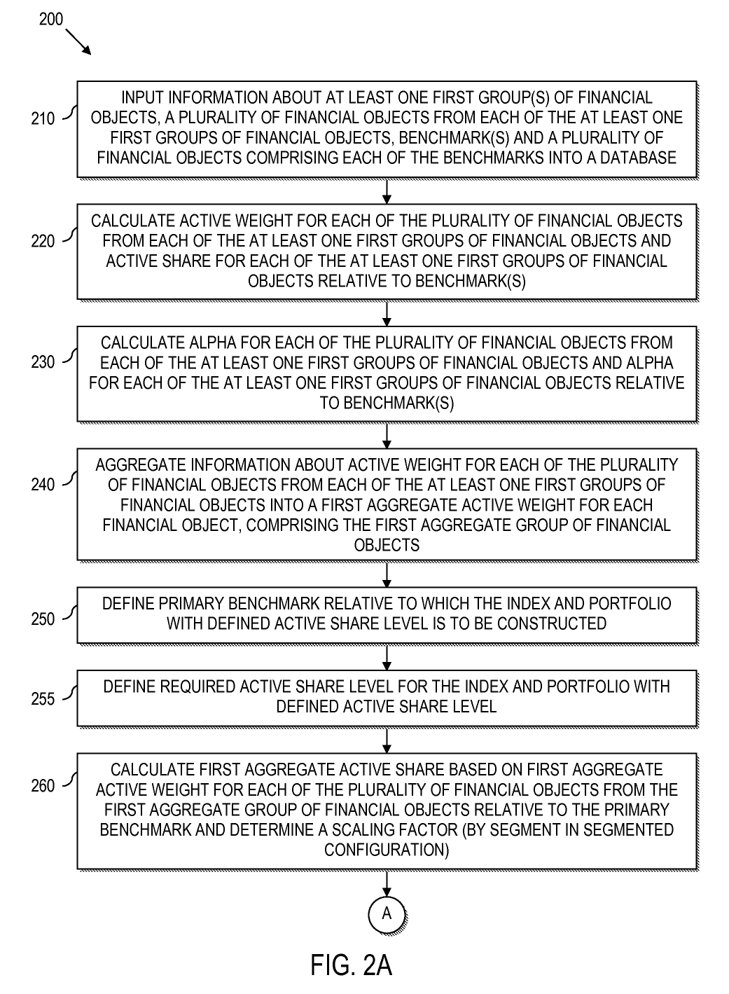

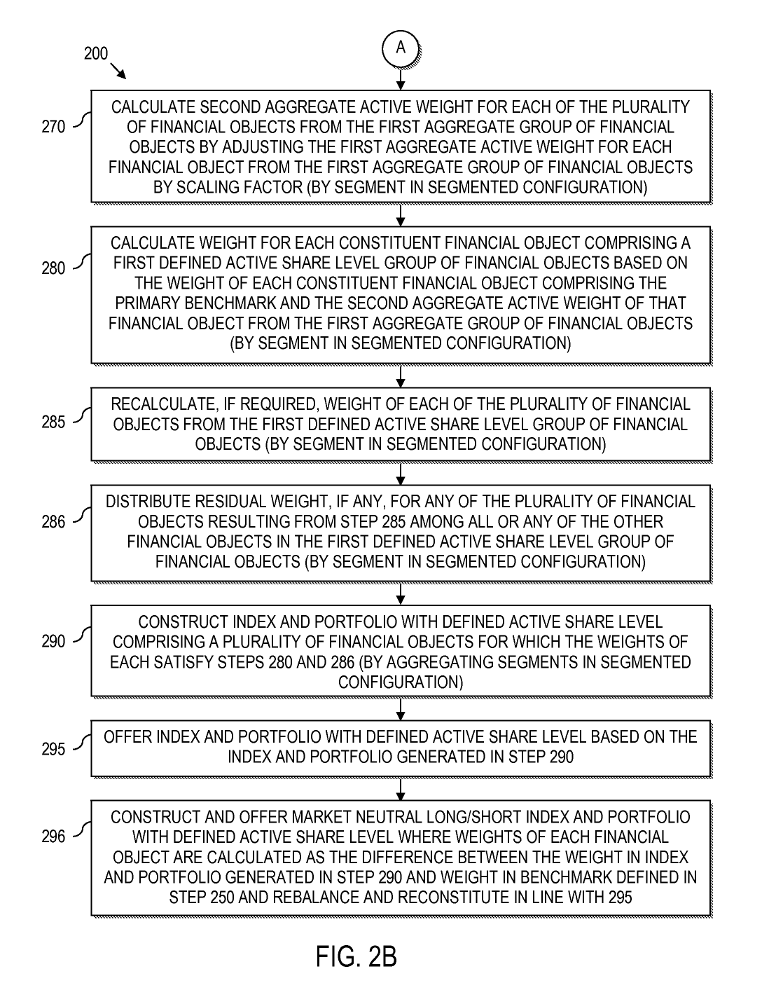

Referring again to FIG. 1, software application 140 is executed by the processor 110 in order to carry out all or some of program flow 200, as shown in FIG. 2, in accordance with an embodiment of the present technology.

Referring specifically to FIGS. 2A-2B with general reference back to FIG. 1, in step 210 of flow 200, information about at least one first group(s) of financial objects, a plurality of financial objects from each of the at least one first groups of financial objects, benchmark(s) and a plurality of financial objects comprising each of the benchmarks, is input into a database, such as database 130. It is possible using this embodiment of the present disclosure to define the at least one first groups of financial objects and benchmarks using whatever criteria is considered suitable. For the sake of example, information about open-ended equity funds focused on the financials sector including their respective portfolio holdings and information about financial indexes focused on the financials sector including their respective constituents is input into a database This step may be performed as described above in connection with FIG. 1, for example. Moreover, the portfolio holdings may be designed to fully or partially replicate and/or measure all or some of the performance, characteristics and/or composition of the financials sector.

In step 220 of flow 200, an active weight for each of the plurality of financial objects from each of the at least one first groups of financial objects and each of the benchmarks is calculated. Also, an active share for each of the at least one first groups of financial objects relative to benchmarks, is calculated. In an illustrative embodiment, a benchmark may be defined by an investment prospectus of the relevant open-ended equity fund. In another illustrative embodiment, a choice of benchmark for each open-ended equity fund may be defined separately as the benchmark which results in the lowest active share for that open-ended equity fund. A routine 150:1, FIG. 1, may be called and executed by the processor 110, FIG. 1, so as to perform this step. Calculated active weights and active shares may be stored in the database 130, for example.

In step 230 of flow 200, additional aspects and/or measures regarding financial objects and/or the at least one first groups of financial objects is calculated based on whatever criteria are considered suitable. In an illustrative embodiment an alpha for each of the plurality of financial objects from each of the at least one first groups of financial objects and an alpha for each of the at least one first groups of financial objects relative to benchmark(s) selected in step 220 is calculated. A routine 150:2, FIG. 1, may be called and executed by the processor 110, FIG. 1, so as to perform this step. Calculated alphas may be stored in the database 130, for example.

In step 240 of flow 200, information regarding an active weight for each of the plurality of financial objects from each of the at least one first groups of financial objects is aggregated into a first aggregate active weight for each financial object. In various illustrative embodiments, information may be aggregated based on:
an equal weight;
a weighting based on the aggregate number of occurrences each financial object is included in the at least one first groups of financial objects;
a measure of active weight for each financial object being of a pre-determined magnitude, for the sake of example, each financial object with active weight of less than e.g. +/−0.5% may be excluded from aggregation;
a measure and/or weight of alpha of each financial object, for the sake of example, active weight for financial objects with a negative alpha may be excluded from aggregation, for the sake of another example, financial objects with a negative alpha may be assigned an inverse active weight;
a measure and/or weight of active share of each of the at least one first groups of financial objects, for the sake of example, active weight for each financial object may be weighted by a factor representing the relative magnitude of active share of the relevant at least one first group of financial objects compared to the magnitude of active share of other at least one first groups of financial objects;
a measure and/or weight of alpha of each of the at least one first groups of financial objects, for the sake of example, active weight for each financial object may be weighted by a factor representing the relative magnitude of alpha of the relevant at least one first group of financial objects compared to the magnitude of alpha of other at least one first groups of financial objects, for the sake of another example, financial objects from the at least one first groups of financial objects where the group has a negative alpha may be assigned an inverse active weight.
   Information may be aggregated based upon other basis. Also, the information aggregation may result in one single group of financial objects, the first aggregate group of financial objects, and a first aggregate active weight for each financial object comprising the group. A routine 150:3, FIG. 1, may be called and executed by the processor 110, FIG. 1, so as to perform this step. Constituents comprising the first aggregate group of financial objects and calculated first aggregate active weights may be stored in the database 130, for example.

In step 250 of flow 200, a primary benchmark is defined relative to which the index and portfolio with defined active share level is to be constructed. In various illustrative embodiments, the primary benchmark may be:
a financial instrument and/or security, e.g., debt, equity, a hybrid, etc.;
an asset and/or liability;
a portfolio of financial instruments and/or securities such as e.g. a fund, an investment entity, an exchange traded note and/or exchange traded fund;
a financial index;
a commodity;
any financial derivative based on any of the above;
a plurality of any of these.
   Moreover, the primary benchmark may be defined in other manners. For instance, the primary benchmark may be more broadly defined as any financial object(s) in any composition and/or structure used as standard against which the performance, characteristics and/or composition of financial object(s) and/or investment(s) can be measured and compared. A routine 150:4, FIG. 1, may be called and executed by the processor 110, FIG. 1, so as to perform this step. Information regarding primary benchmark may be stored in the database 130, for example.

In step 255 of flow 200, a required active share level for the index and portfolio with defined active share level is defined using whatever criteria are considered suitable. In various illustrative embodiments, required active share level may be defined to be:
50% with +/−5% magnitude of deviation;
no less than 50%; or
between 50% and 70%.
   The above illustrations are presented by example. The active share level may be defined in other manners. A routine 150:5, FIG. 1, may be called and executed by the processor 110, FIG. 1, so as to perform this step. Information regarding required active share level may be stored in the database 130, for example.

In various illustrative embodiments, a required active share level may represent a specific:
investment and/or allocation profile;
return profile and/or expected return profile;
risk profile and/or expected risk profile;
diversification profile;
any investment and/or allocations constraints;
any combination of the above;
   More broadly, the required active share level may represent various aspects of an active exposure, portfolio and/or investment defined to meet specific criteria and maintained in a consistent way.

In step 260 of flow 200, a first aggregate active share based on first aggregate active weight for each of the plurality of financial objects from the first aggregate group of financial objects relative to the primary benchmark is calculated and a scaling factor is determined. In an illustrative embodiment, the scaling factor may be a ratio between the required active share level and the calculated first aggregate active share. A routine 150:6, FIG. 1, may be called and executed by the processor 110, FIG. 1, so as to perform this step. Calculated first aggregate active share and scaling factor may be stored in the database 130, for example.

In step 270 of flow 200, a second aggregate active weight for each of the plurality of financial objects from the first aggregate group of financial objects is calculated. The calculations may be performed by adjusting the first aggregate active weight for each financial object from the first aggregate group of financial objects by the scaling factor determined in step 260. In an illustrative embodiment, adjusting by the scaling factor may be implemented by multiplying by the scaling factor. A routine 150:7, FIG. 1, may be called and executed by the processor 110, FIG. 1, so as to perform this step. Calculated second aggregate active weights may be stored in the database 130, for example.

In step 280 of flow 200, a weight for each constituent financial object comprising a first defined active share level group of financial objects is calculated. The calculations may be based on the weight of each constituent financial object comprising the primary benchmark and the second aggregate active weight of that financial object from the first aggregate group of financial objects. In an illustrative embodiment, this step may involve calculating the sum of, the weight of each constituent financial object comprising the primary benchmark and the second aggregate active weight of that financial object from the first aggregate group of financial objects. A routine 150:8, FIG. 1, may be called and executed by the processor 110, FIG. 1, so as to perform this step. Calculated weights may be stored in the database 130, for example.

In step 285 of flow 200, if required, a weight of each of the plurality of financial objects from the first defined active share level group of financial objects is recalculated subject to whatever additional criteria is considered suitable. In an illustrative embodiment, additional criteria may include measures of appropriateness of exposure and/or excessive exposure, e.g., liquidity requirements, maximum or minimum limit and/or concentration, risk diversification, etc. A routine 150:9, FIG. 1, may be called and executed by the processor 110, FIG. 1, so as to perform this step. Recalculated weights may be stored in the database 130, for example.

In step 286 of flow 200, if any, residual weight for any of the plurality of financial objects resulting from step 285 is distributed among all or any of the other financial objects in the first defined active share level group of financial objects using whatever criteria are considered suitable. In various illustrative embodiments, residual weight may be distributed:
equally among all or any of the other financial objects;
based on respective weight of each of the other financial objects in the first defined active share level group of financial objects;
based on respective active weight of each of the other financial objects in the first defined active share level group of financial objects.
   The above examples are presented by way of illustration. Residual weight may be distributed using other techniques. A routine 150:10, FIG. 1, may be called and executed by the processor 110, FIG. 1, so as to perform this step. Recalculated weights may be stored in the database 130, for example.

If required, step 285 and step 286 are performed until all additional criteria are satisfied.

In step 290 of flow 200, an index and portfolio with defined active share level is constructed comprising a plurality of financial objects for which the weights of each satisfy steps 280 to 286. A routine 150:11, FIG. 1, may be called and executed by the processor 110, FIG. 1, so as to perform this step. Information about the index and portfolio with defined active share level may be stored in the database 130, for example.

In step 295 of flow 200, an index and portfolio with defined active share level is offered based on the index and portfolio generated in step 290. In various illustrative embodiments, the financial objects comprising the index and portfolio with defined active share level may be rebalanced and reconstituted. In an illustrative embodiment, financial objects may be rebalanced and reconstituted based on one or several of;
changes related to any aspect of the at least one first groups of financial objects;
changes related to any aspect of any of the plurality of financial objects from the at least one first groups of financial objects;
changes related to any aspect of the benchmark(s) and/or primary benchmark.
changes related to any aspect of any of the plurality of financial objects comprising the benchmark(s) and/or primary benchmark.
   The above examples are presented by way of illustration. Rebalancing may be carried out in alternative manners. A routine 150:12, FIG. 1, may be called and executed by the processor 110, FIG. 1, so as to perform this step.

In step 296 of flow 200, an additional, market neutral long/short (approximately neutral in weights and/or notional values of the aggregate long and short positions) index and portfolio with defined active share level is generated and offered. Here, the weights of each financial object may be calculated as the difference between the weight in index and portfolio generated in step 290 and the weight in benchmark defined in step 250. Financial objects for which weights are positive form part of the long position in the market neutral long/short index and portfolio. Correspondingly, financial objects for which weights are negative form part of the short position in the market neutral long/short index and portfolio. The market neutral long/short portfolio is rebalanced and reconstituted when rebalancing and reconstitution in step 295 is performed. A routine 150:13, FIG. 1, may be called and executed by the processor 110, FIG. 1, so as to perform this step. Information about the market neutral long/short index and portfolio with defined active share level may be stored in the database 130, for example.

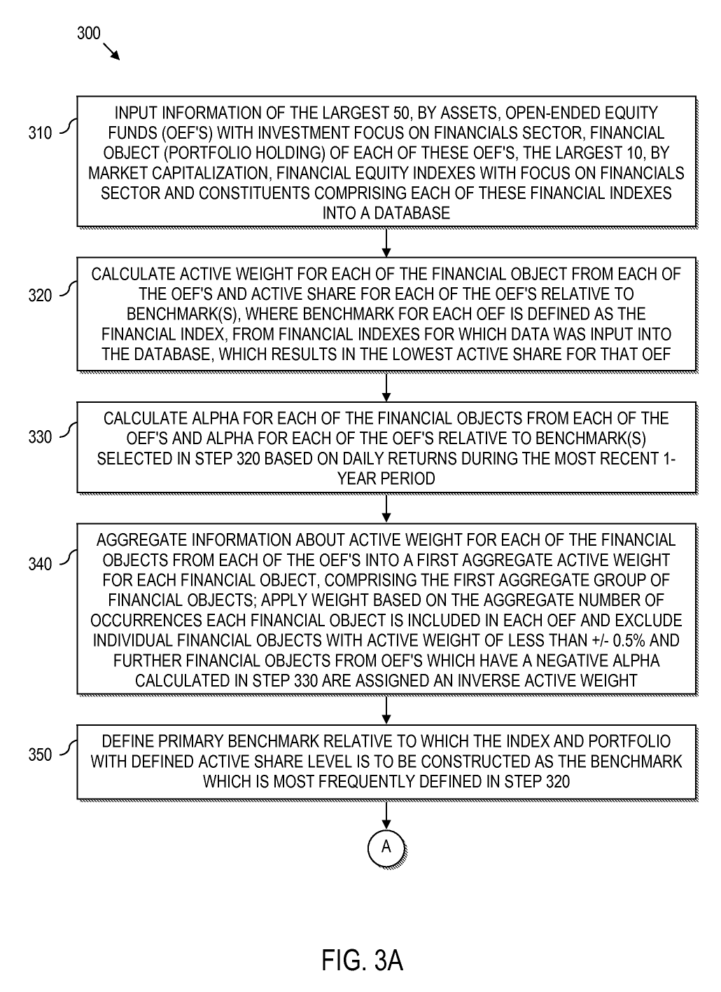

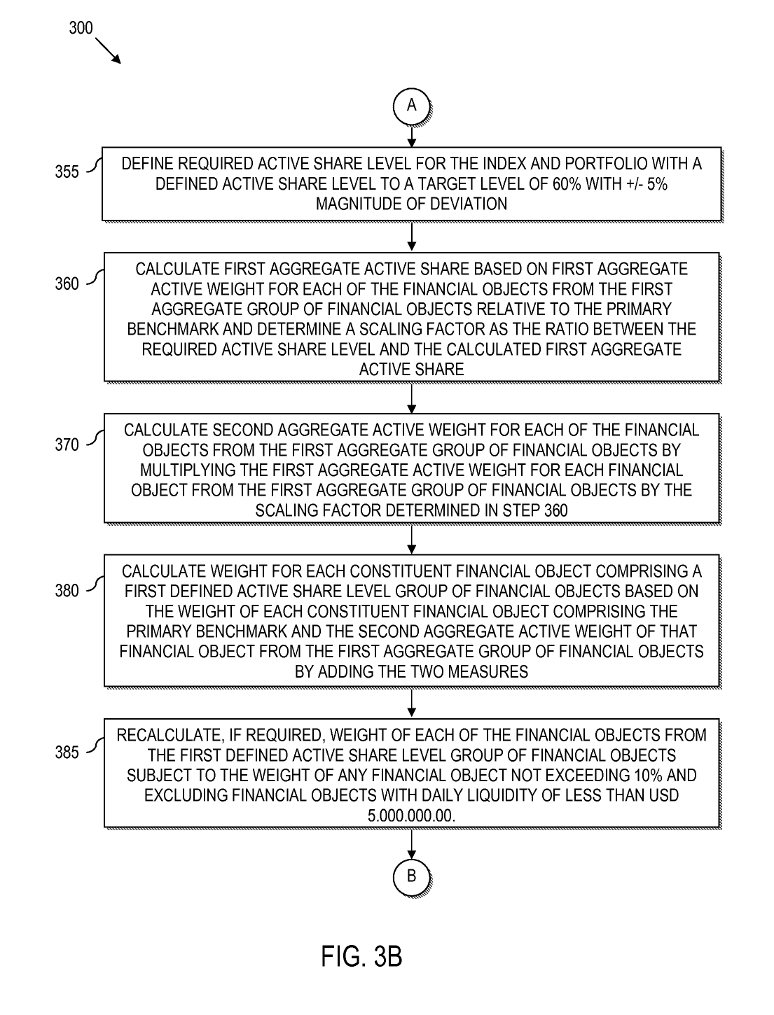

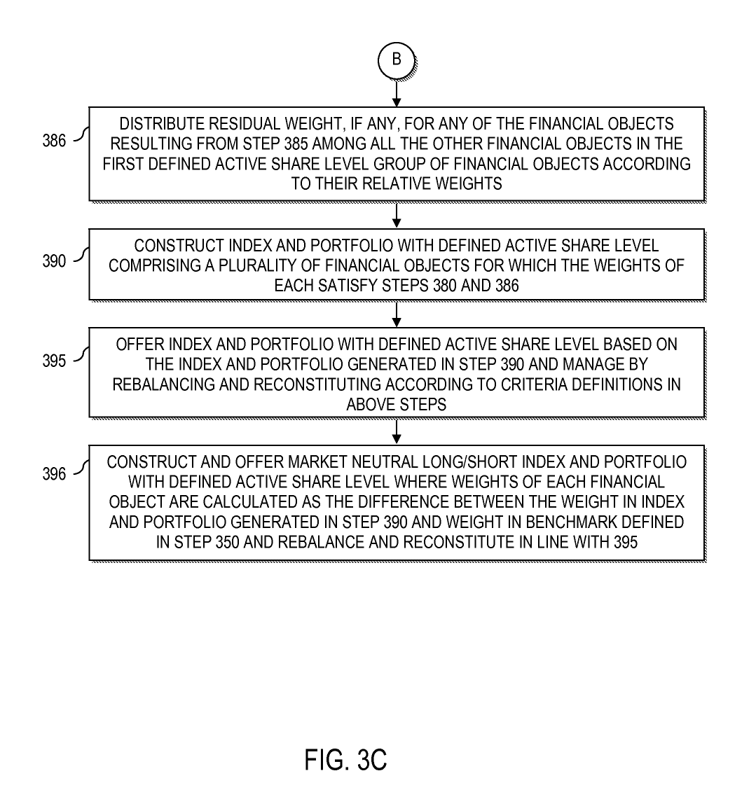

FIGS. 3A-3C show a more specific illustrative embodiment of the present technology, according to further aspects of the present disclosure. Referring again briefly to FIG. 1, software application 140 is executed by the processor 110 in order to carry out a program flow 300 stored in memory 120, as shown in FIGS. 3A-3C.

Referring to FIGS. 3A-3C, in step 310 of flow 300, in an illustrative embodiment, information of the X largest first groups of financial objects is input into a database, such as database 130. The first groups of financial objects may include for example, the 50 largest by assets, open-ended equity funds (OEFs) with investment focus on the financials sector and portfolio holdings (financial objects) from each of these OEFs. Also, information on the Y largest benchmarks is input into the database. For example, the 10 largest by market capitalization, financial equity indexes with focus on the financials sector and constituents comprising each of these financial indexes, is input into the database. Here, although the example is 50 and 10, it is understood that X and Y are any desired integer. The input information may correspond to last available information for each, e.g. last available information may be at different calendar dates for any of OEFs and/or financial indexes. This step may be performed as described above in connection with FIG. 1, for example.

In step 320 of flow 300, an active weight for each of the financial objects from each of the OEFs and an active share for each of the OEFs relative to the benchmark(s) is calculated. In an illustrative embodiment, a benchmark may be defined separately for each OEF as the financial index, from financial indexes for which information was input into database 130 in step 310. This may result in the lowest active share for that OEF. A routine 150:1, FIG. 1, may be called and executed by the processor 110, FIG. 1, so as to perform this step. Calculated active weights and active shares may be stored in the database 130, for example.

In step 330 of flow 300, an alpha for each of the financial objects from each of the OEFs and an alpha for each of the OEFs relative to benchmark(s) selected in step 320 is calculated. In an illustrative embodiment, this step may be performed based on a predetermined period, e.g., daily returns during the most recent 1-year period. A routine 150:2, FIG. 1, may be called and executed by the processor 110, FIG. 1, so as to perform this step. Calculated alphas may be stored in the database 130, for example.

In step 340 of flow 300, information regarding an active weight for each of the financial objects from each of the OEFs is aggregated into a first aggregate active weight for each financial object, comprising the first aggregate group of financial objects. In an illustrative embodiment, firstly, information is weighted based on the aggregate number of occurrences each financial object is included in each OEF. Secondly, individual financial objects with active weight of less than a predetermined amount, e.g., +/−0.5%, are excluded from aggregation. Thirdly, financial objects from OEFs that have a negative alpha calculated in step 330 are assigned an inverse active weight. A routine 150:3, FIG. 1, may be called and executed by the processor 110, FIG. 1, so as to perform this step. Financial objects comprising the first aggregate group of financial objects and calculated first aggregate active weights may be stored in the database 130, for example.

In step 350 of flow 300, a primary benchmark is defined relative to which the index and portfolio with defined active share level is to be constructed. In an illustrative embodiment, the primary benchmark may be defined as the benchmark which is most frequently defined in step 320. A routine 150:4, FIG. 1, may be called and executed by the processor 110, FIG. 1, so as to perform this step. Information regarding primary benchmark may be stored in the database 130, for example.

In step 355 of flow 300, a required active share level for the index and portfolio with defined active share level is defined. In an illustrative embodiment, the required active share level may be defined to be a target level, e.g., 50% with +/−5% magnitude of deviation. A routine 150:5, FIG. 1, may be called and executed by the processor 110, FIG. 1, so as to perform this step. Information regarding required active share level may be stored in the database 130, for example.

In step 360 of flow 300, a first aggregate active share based on first aggregate active weight for each of the financial objects from the first aggregate group of financial objects relative to the primary benchmark is calculated and a scaling factor is determined. In an illustrative embodiment, the scaling factor may be a ratio between the required active share level and the calculated first aggregate active share. For the sake of example, if the required active share level is 50% and the calculated first aggregate active share is 40%, then the scaling factor is 1.25. A routine 150:6, FIG. 1, may be called and executed by the processor 110, FIG. 1, so as to perform this step. Calculated first aggregate active shares and scaling factors may be stored in the database 130, for example.

In step 370 of flow 300, a second aggregate active weight for each of the financial objects from the first aggregate group of financial objects is calculated. The second aggregate weights are calculated by adjusting the first aggregate active weight for each financial object from the first aggregate group of financial objects by the scaling factor determined in step 360. In an illustrative embodiment, adjustment by the scaling factor may be implemented by multiplying the first aggregate active weight for one of the financial objects by the scaling factor. For the sake of example, if the scaling factor is 1.25 and the first aggregate active weight for one of the financial objects is 3%, then the second aggregate active weight for that financial object is 3.75%, for the sake of another example, if the scaling factor is 1.25 and the first aggregate active weight for one of the financial object is −3%, then the second aggregate active weight for that financial object is −3.75%. A routine 150:7, FIG. 1, may be called and executed by the processor 110, FIG. 1, so as to perform this step. Calculated second aggregate active weights may be stored in the database 130, for example.

In step 380 of flow 300, a weight for each constituent financial object comprising a first defined active share level group of financial objects is calculated based on the weight of each constituent financial object comprising the primary benchmark and the second aggregate active weight of that financial object from the first aggregate group of financial objects. In an illustrative embodiment, this step may involve calculating the sum of, the weight of each constituent financial object comprising the primary benchmark and the second aggregate active weight of that financial object from the first aggregate group of financial objects. For the sake of example, if the weight of one constituent financial object comprising the primary benchmark is 5% and the second aggregate active weight of that financial object from the first aggregate group of financial objects is 3.75%, then the weight of that financial object in the first defined active share level group of financial objects is 8.75%. A routine 150:8, FIG. 1, may be called and executed by the processor 110, FIG. 1, so as to perform this step. Calculated weights may be stored in the database 130, for example

In step 385 of flow 300, if required, weight of each of the financial objects from the first defined active share level group of financial objects is recalculated subject to additional criteria. In an illustrative embodiment, additional criteria may include firstly, a maximum weight rule which may restrict the weight of any individual financial object. For the sake of example, a maximum weight rule may indicate that the weight of any financial object may not exceed 10%. Secondly, a liquidity rule may restrict the exposure to financial objects with daily liquidity of less than a predefined threshold level. For the sake of example, a liquidity rule may specify that financial objects with daily liquidity of less than USD 5,000,000.00 are excluded. A routine 150:9, FIG. 1, may be called and executed by the processor 110, FIG. 1, so as to perform this step. Recalculated weights may be stored in the database 130, for example.

In step 386 of flow 300, if any, residual weight for any of the financial objects resulting from step 385 is distributed among all or any of the other financial objects in the first defined active share level group of financial objects. In an illustrative embodiment, residual weight may be distributed based on relative weight of each of the other financial object in the first defined active share level group of financial objects. For the sake of example, if the weight of financial object A is twice the weight of financial object B, then the distribution of the residual weight between financial object A and B will be in the same proportion. A routine 150:10, FIG. 1, may be called and executed by the processor 110, FIG. 1, so as to perform this step. Recalculated weights may be stored in the database 130, for example.

In step 390 of flow 300, an index and portfolio with defined active share level is constructed comprising a plurality of financial objects for which the weights of each satisfy steps 380 to 386. A routine 150:11, FIG. 1, may be called and executed by the processor 110, FIG. 1, so as to perform this step. Information regarding the index and portfolio with defined active share level may be stored in the database 130, for example.

In step 395 of flow 300, an index and portfolio with defined active share level is offered based on the index and portfolio generated in step 390. In an illustrative embodiment, the financial objects comprising the index and portfolio with defined active share level may be rebalanced and reconstituted. In an illustrative embodiment, financial objects may be rebalanced and reconstituted based on;
changes related to any aspect of any financial object from any of the OEFs. For the sake of example, changes in weights of financial objects from any of the OEFs e.g. caused by adding new financial objects, exiting financial objects, rebalancing financial objects, etc;
changes related to any aspect of any of the OEFs, for the sake of example financial objects of an OEF for which assets have increased resulting in the OEF ranking among the largest 50, by assets, OEFs with investment focus on financials sector may be included. For the sake of another example financial objects of an OEF for which alpha has turned negative may be excluded;
changes related to any aspect of any of the constituents comprising the benchmark. For the sake of example, changes in weight of any of the constituents comprising the benchmark causing changes in active weights for any financial object from any of the OEFs resulting in the relevant active weight falling below a minimum level, e.g. +/−0.5%;
changes related to any aspect of the benchmark. For the sake of example, performance of the benchmark, positive or negative, causing alpha calculated for any of the OEFs to e.g. change from positive to negative or from negative to positive resulting in financial objects for that OEF to be either excluded or included or the weights inverted.
   A routine 150:12, FIG. 1, may be called and executed by the processor 110, FIG. 1, so as to perform this step.

In step 396 of flow 300, an additional, market neutral long/short (approximately neutral in weights and/or notional values of the aggregate long and short positions) index and portfolio with defined active share level is generated and offered. Here, weights of each financial object are calculated as the difference between the weight in the index and the portfolio generated in step 390, and weight in the benchmark defined in step 350. Financial objects for which weights are positive form part of the long position in the market neutral long/short index and portfolio. Financial objects for which weights are negative form part of the short position in the market neutral long/short index and portfolio. The market neutral long/short portfolio is rebalanced and reconstituted when rebalancing and reconstitution in step 395 is performed. A routine 150:13, FIG. 1, may be called and executed by the processor 110, FIG. 1, so as to perform this step. Information about the market neutral long/short index and portfolio with defined active share level may be stored in the database 130, for example.

In various embodiments, the present disclosure can be configured to provide consistent level and/or segmented contribution to active share derived from various segments of the index and portfolio with defined active share level. In an illustrative embodiment the segmented contribution is equal to the proportion of the segment itself in relation to the overall index and portfolio with defined active share level.

With reference back to FIG. 2, in an illustrative embodiment, the benchmark defined in step 250 can e.g. be divided into three approximately equal parts, or sub-benchmarks, representing the different relative sizes of benchmark constituents such as large/mid/small constituent entities. Once the required active share level for the index and portfolio with defined active share level is defined in step 255 of flow 200, steps 260 to 286 and the corresponding routines 150:6 to 150:10 can be carried out separately for each of the three sub-indexes/sub-portfolios vs. sub-benchmarks. This ensures that the required active share level is consistent and/or the contribution to active share is proportional (in this case equal) from the various parts of the index and portfolio with defined active share level. In step 290 of flow 200, an index and portfolio with defined active share level based on segmented configuration is constructed by aggregating the sub-indexes/sub-portfolios comprising a plurality of financial objects for which the weights of each satisfy steps 280 to 286. In step 295 of flow 200, an index and portfolio with defined active share level based on such segmented configuration is offered based on the index and portfolio generated in step 290 and the financial objects comprising the index and portfolio with defined active share level based on segmented configuration may be rebalanced and reconstituted.

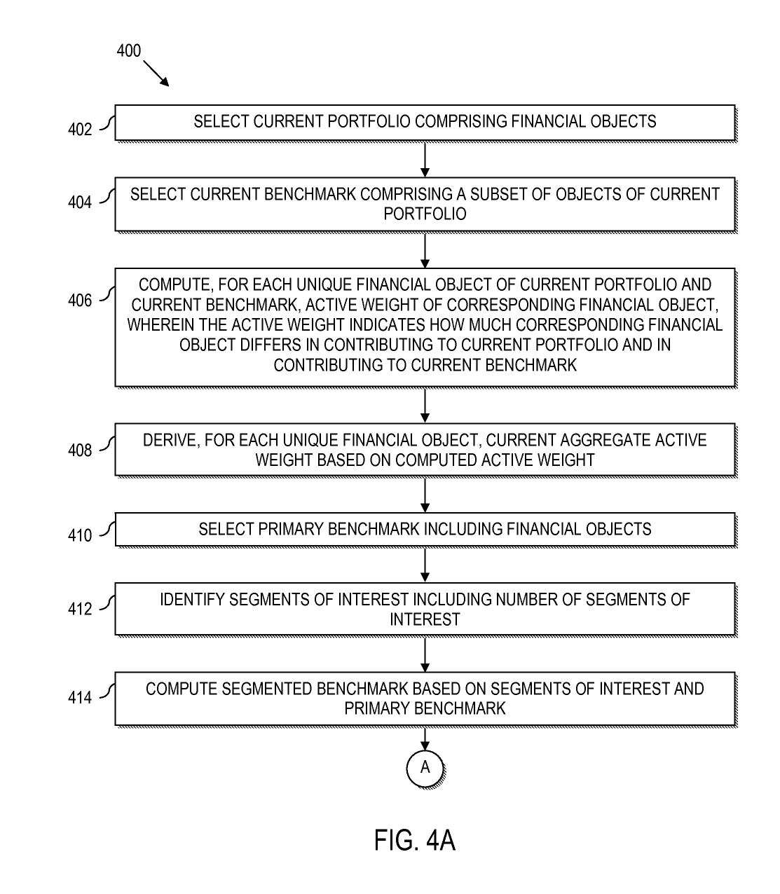

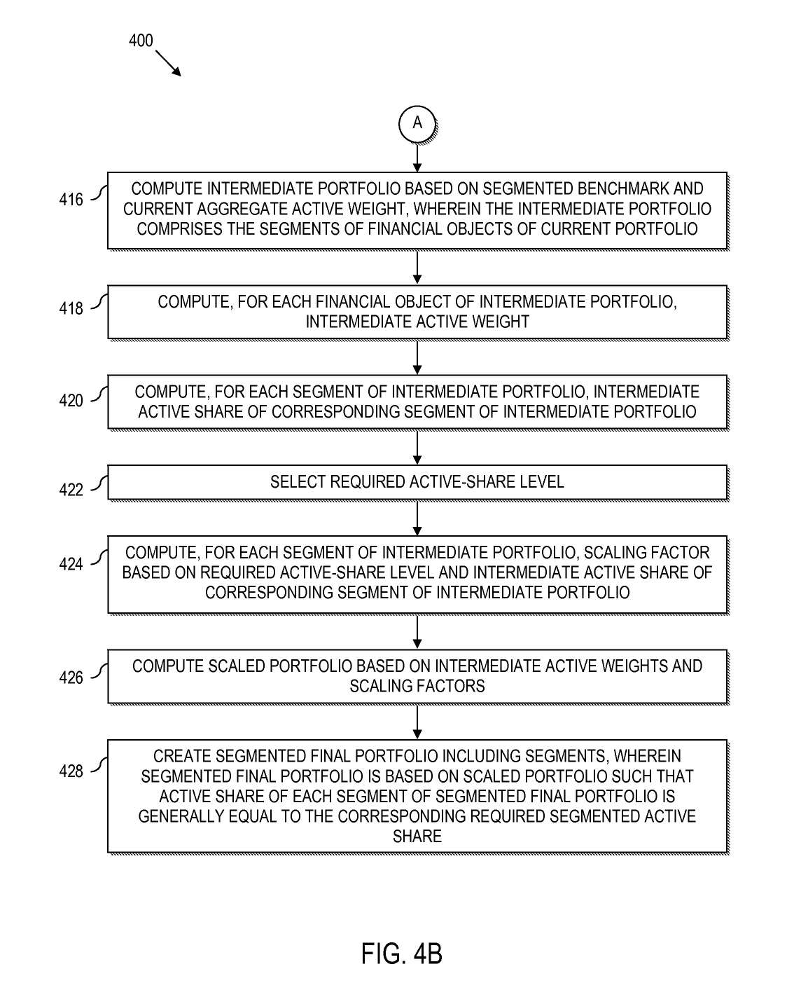

Turning now to FIGS. 4A-4B, a flowchart illustrating a method 400 for creating a portfolio with a segmented (in this case equal) active share is shown. Referring again briefly to FIG. 1, software application 140 is executed by the processor 110 in order to carry out a program flow 400 stored in memory 120, as shown in FIGS. 4A-4B.

At 402, a portfolio comprising financial objects is selected as a current portfolio. As used herein, “portfolio” is used to refer generally to a grouping of financial objects. In this regard, a portfolio may comprise a previously existing grouping of financial objects, or a user may define a “custom” portfolio by selecting financial objects of interest. For instance, a portfolio can include but is not limited to: a held/managed portfolio (i.e., a group of financial objects such as equities, debt, cash, etc., or combinations thereof), an index, a fund, a hypothetical group of financial objects, etc. As noted in greater detail herein, a particular financial object selected into the portfolio may itself represent a portfolio of financial instruments and/or securities.

While it is conceivable that there is only one portfolio, in most embodiments, there will be several portfolios of financial objects chosen, thus selecting current portfolios. In other words, the selecting may be selecting more than one current portfolio (as opposed to just one portfolio), where each portfolio of the current portfolios comprises financial objects.

In embodiments with more than one current portfolio, the financial objects of one portfolio do not need to be identical to the financial objects of another portfolio. In other words, a select portfolio of the current portfolios may include at least one financial object not included in another portfolio of the current portfolios. However, there is no such requirement. Therefore, the current portfolios may have identical financial objects (in same or different percentages). The current portfolios may alternatively have some financial objects that overlap, or may have no financial objects in common. Further, the number of financial objects in the portfolios does not need to be identical. For example, there may be five portfolios selected as the current portfolios:

Portfolio_1 is a held portfolio with financial objects A, B, C, and D;

Portfolio_2 is an index with financial objects A, B, C, and D;

Portfolio_3 is a mutual fund with financial objects A, E, and F;

Portfolio_4 is a hypothetical portfolio with financial objects G, H, I, J, K, L, and M; and

Portfolio_5 is a managed portfolio with financial objects A, B, and D.

At 404, a current benchmark comprising a subset of the financial objects of the current portfolio is selected. Thus, a current benchmark may have some or all of the financial objects of the current portfolio. However, in some embodiments, the current benchmark may have more financial objects than the current portfolio. In some embodiments with more than one current portfolio, there is a current benchmark for each current portfolio. In this regard, each current benchmark may be unique to its associated current portfolio. Alternatively, the same current benchmark may be used for more than one current portfolio.

The current benchmark may be identical to the current portfolio, or in an embodiment with more than one current portfolio, the current benchmark may be identical to one of the portfolios. In other words, the current benchmark may comprise an entirety of the financial objects of the current portfolio, or in an embodiment with more than one current portfolio, the current benchmark may comprise a subset of the financial objects of a select portfolio of the current portfolio. Further, the current benchmark may include other financial objects not included in any of the portfolios.

For example, using the 5-portfolio example above, the current benchmark may include financial objects A, F, H, L, and N. As another example, a selected current benchmark may be identical to Portfolio_1, because a subset can include all of the objects in a set. However, the current benchmark should include at least one of the financial objects included in the portfolios.

At 406, an active weight is computed for each unique financial object in the current portfolio and current benchmark. The active weight indicates how much the corresponding financial object differs in contributing to the current portfolio, and in contributing to the current benchmark. Thus for instance, the active weight indicates a difference in how much the corresponding financial object contributes to the current portfolio with respect to how much the corresponding financial object contributes to the current benchmark. By way of example, an active weight can represent a difference between the weight of a security in a portfolio and the weight of that security in the portfolio's benchmark. As an example, computing, for each financial object, an active weight of the corresponding financial object can thus be carried out by subtracting a contribution of the financial object to the current benchmark from a contribution of the financial object to the current portfolio.

For instance, assume there is one current portfolio, e.g., Portfolio_1, with financial objects A, B, C, and D. Assume that the current benchmark associated with Portfolio_1 includes financial objects A, B, D, E, and F. Here, the unique financial objects include A, B, C, D, E, and F. Thus, a scan is made through each current portfolio and each benchmark, and (at least conceptually), a list is made of each unique instance of the included financial objects.

Recall that the active weight of a financial object indicates how much that financial object differs from the current portfolio to the current benchmark. For example, if financial object A comprises 4.3% of Portfolio_1 and comprises 6.7% of the current benchmark, then the active weight for A is −2.4% (i.e., 4.3%−6.7%=−2.4%). As a general rule for a traditional long-only portfolio, the sum of the active weights for any given portfolio will be approximately zero. However, the sum of the absolute values of the active weights can be zero or a positive number.

In an example with one current portfolio that has seventeen financial objects and a current benchmark with the same seventeen financial objects, then there should be an active weight computed for all seventeen financial objects resulting in seventeen separate active weights. In another example with one current portfolio that has seventeen financial objects and a current benchmark with sixteen financial objects shared with the current portfolio and three financial objects not included in the current portfolio, then there will be twenty active weights computes (i.e., sixteen common, one in the portfolio but not in the benchmark, and three in the benchmark but not in the portfolio: 16+1+3=20).

In an embodiment with more than one current portfolio, an active weight is computed for each unique financial object of a select current portfolio and current benchmark for each current portfolio. For example, if

Portfolio_6 includes A, B, C, D, E, F, and G;

Portfolio_7 includes A, B, C, D H, I, and J;

Benchmark_1 includes A, B, C, D, E, K, and L; and

Benchmark_2 includes A, B, C, D, J, and M,

then at least the following computations should occur. For Portfolio_6 and Benchmark_1: there are five common objects (A-E), two objects in Portfolio_6 not included in Benchmark_1 (F and G), and two objects in Benchmark_1 not included in Portfolio_6 (K and L) for a total of nine unique objects. Therefore, for Portfolio_6 and Benchmark_1, there are nine active weight computations. For Portfolio_7 and Benchmark_2: there are five common objects (A-D and J), two objects in Portfolio_7 not included in Benchmark_2 (H and I), and one object in Benchmark_2 not included in Portfolio_7 (M) for a total of eight unique objects. Therefore, for Portfolio_7 and Benchmark_2, there are eight active weight computations. As such, in the example above, there are at least seventeen active weight computations (nine from the first portfolio-benchmark pair and eight from the second portfolio-benchmark pair), even though there are only thirteen unique financial objects in total between all four.

At 408, a current aggregate active weight is derived for each unique financial object of the current portfolio and the current benchmark based on the computed active weights for a corresponding financial object. In an embodiment with only one current portfolio, the current aggregate active weight of a financial object can simply be the computed active weight for that object. In embodiments with several current portfolios, the aggregate active weight for a financial object is based on all of the computed active weights for that financial object. For example, the computed active weights may be averaged: if financial object A has active weights of 0.77%, 2.13%, and −1.18%, then the aggregate active weight of A (using an average) is approximately 0.57%. Thus, no matter how many current portfolios were present at the beginning, there is one current aggregate active weight for each unique financial object.

At 410, a primary benchmark including financial objects is selected. The primary benchmark may be one of the current benchmarks used in the previous steps. Alternatively, the primary benchmark may be an independent benchmark not used in any of the previous steps. As with the current benchmarks, the primary benchmark may include a subset of the financial objects of the current portfolios and may include financial objects not in any of the current portfolios. Thus, no matter how many current benchmarks were present in the beginning, there is one primary benchmark in this example.

At 412, a number of segments of interest are identified along with the segments of interest themselves. In an example implementation, the identified segments may include both the identity of the segment and a desired proportion within a final portfolio used to create a required segmented active share. Moreover, in an example implementation, identifying segments of interest including a number of segments of interest; further includes associating subsets of the financial objects within the primary benchmark with each of the segments of interest.

For example, the segments of interest can be a type of capitalization of the financial objects (e.g., large-cap segment, mid-cap segment, and small-cap segment (three segments in various proportions)), share within the portfolio (large share, mid share, and small share (three segments in various proportions)), belonging to the primary benchmark or not (two segments in various proportions); U.S.A., U.K., Japan, Brazil, and rest of the world (five segments in various proportions); etc.), industry segment (e.g., computer technology, retail, food service, pharmaceutical (four segments in various proportions)), etc. or any combination of segments of interest. In an illustrative example, the financial objects of the primary benchmark may be associated, in exclusive subsets, to the segments of interest. Using the “share within the portfolio” segments of interest to figure out the benchmark associations of the financial objects of the primary benchmark, the financial objects within the primary benchmark are ranked. The ranking may be based on the percentage that each financial object contributes to the overall makeup of the primary benchmark. Then, the large-share segment is set by determining the fewest number of financial objects needed to get to the appropriate ratio (e.g., approximately thirty-three percent, i.e., one-third for an example with three equal segments) of the primary benchmark. The same is done for the mid-share segment, excluding the financial objects already in the large-share segment. The rest are placed in the small-share segment. Of course, other example implementations can have a different number of segments. Moreover, the portion of each segment need not be equal.

For example, a benchmark is selected as the primary benchmark and includes the following percentage makeup: A (13%), B (15%), C (18%), D (5%), E (3%), F (7%), G (11%), H (8%), I (9%), J (8%), and K (3%). If “share within the portfolio” is used as a segmenting strategy, then the primary benchmark would be:

large-share segment: C and B, because C+B=33% (smallest number of financial objects to get to 33%);

mid-share segment: A, G, and I, because A+G+I=33% (smallest number of financial objects excluding C and B to get to 33%); and

small-share segment: D, E, F, H, J, and K (the rest of the financial objects).

Another method for associating the financial objects of the primary benchmark with segments of interest may be based on industry segment, where no calculations are needed, because the financial objects meet a definition. For example, if the segments of interest are industry segments and the primary benchmark has the following financial objects: A (retail), B (computer technology), C (retail), D (pharmaceutical), E (food service), F (retail), and G (food service), then the financial objects of the primary benchmark would be:

computer-technology segment: B;

retail segment: A, C, and F;

food-service segment: E and G; and

pharmaceutical segment: D.

At 414, a segmented benchmark is computed based on the segments of interest and the primary benchmark. For instance, the segmented benchmark may be computed by segmenting the primary benchmark based on the segments of interest. For example, each segment of interest within the primary benchmark can be seen as its own sub-benchmark. Thus, it may be desirable to set each segment to one-hundred percent. As such, each financial object's contribution to a segment of the segmented benchmark may be determined by dividing the financial object's percentage contribution to the primary benchmark by the sum of percentage contribution to the primary benchmark of every financial object within the segment.

As an illustrative example, computing a segmented benchmark may include segmenting the primary benchmark into a number of segments equal to the number of segments of interest based on the segments of interest. For each financial object within the primary benchmark, a segmented benchmark value is computed by dividing a value of the corresponding financial object of the primary benchmark by a sum of the values of all the values of the financial objects within the segment of the primary benchmark in which the corresponding financial object is located.

For instance, a segment of an example primary benchmark may include A (8.74%), B (6.15%), C (4.91%), D (4.68%), E (4.63%), and F (4.29%). To figure out A's contribution to the segmented benchmark, use the following equation: A/(A+B+C+D+E+F)=8.74%/(8.74%+6.15%+4.91%+4.68%+4.63%+4.29%)=8.74%/33.40%=26.17% as A's share of the first segment. The rest of the financial objects in the first segment are calculated similarly. Further, this process is repeated for each segment, so when the aggregate contributions of all of the financial objects in the segmented benchmark are summed, the result is equal to the number of segments of interest.

At 416, an intermediate portfolio is computed based on the segmented benchmark and the current aggregate active weights. Here, the intermediate portfolio comprises segments of the financial objects of the current aggregate active weight.

In an illustrative example, a segmented benchmark may be computed by segmenting the primary benchmark into a number of segments equal to the number of segments of interest based on the segments of interest. For each financial object within the primary benchmark, a segmented benchmark value is computed by dividing a value of the corresponding financial object of the primary benchmark by a sum of the values of all the values of the financial objects within the segment of the primary benchmark in which the corresponding financial object is located. Correspondingly, in this example, an intermediate portfolio may be computed by segmenting the intermediate portfolio into a number of segments equal to the number of segments of interest based on the segments of interest. For each financial object within the intermediate portfolio, a segmented aggregate active weight is computed by dividing a sum of a value of the corresponding financial object of the primary benchmark and a value of the current aggregate active weight of the corresponding financial object by a sum of the values of all the values of the financial objects within the segment of the current benchmark and the current aggregate active weights in which the corresponding financial object is located.

As another example, the current aggregate active weights can be segmented similarly to the primary benchmark, such that the financial objects per segment of the segmented benchmark are the same as the financial objects per segment of the intermediate portfolio. For example, if the segments of the segmented benchmark are:

Segment_1: A, B, C, D;

Segment_2: E, F, G, H, I; and

Segment_3: J, K, L, M, N, O, P, Q, R,

then the segments of the intermediate portfolio are:

Segment_1: A, B, C, D;

Segment_2: E, F, G, H, I; and

Segment_3: J, K, L, M, N, O, P, Q, R.

In other words, the financial objects are identical between a segment of the segmented benchmark and a corresponding segment of the intermediate portfolio, even though the individual contributions of each financial object to the segment may be different.

The individual contributions of the financial objects of the intermediate portfolio are calculated similarly to the calculations at 414. However, instead of using the primary benchmark directly, the intermediate portfolio adds the current aggregate active weights to the primary benchmark. For example, using the example in 414:

a segment of the primary benchmark includes: A (8.74%), B (6.15%), C (4.91%), D (4.68%), E 4.63%), and F (4.29%), and

the current aggregate active weights for the financial objects in that segment are: W_{A} (−0.77%), W_{B} (−0.23%), W_{C} (−0.72%), W_{D} (0.40%), W_{E} (−0.08%), and W_{F} (−0.60%).

To figure out A's contribution to the intermediate portfolio, use the following equation: (A+W_{A})/((A+W_{A})+(B+W_{B})+(C+W_{C})+(D+W_{D})+(E+W_{E})+(F+W_{F}))=7.97%/(7.97%+5.92%+4.19%+5.08%+4.55%+3.69%)=7.97%/31.40%=25.38%. The rest of the financial objects in the first segment are calculated similarly. Further, this process is repeated for each segment such that the aggregate contributions of all financial objects within a segment add up to one.

At 418, intermediate active weights are computed for each financial object of the intermediate portfolio. The intermediate active weights are computed by subtracting a financial object's contribution to the segmented benchmark from the financial object's contribution to the intermediate portfolio. Using the example above in 416, the intermediate active weight for financial object A is 25.38%−26.17%=−0.79%. The rest of the intermediate active weights are computed similarly.

At 420, an active share of each segment of the intermediate portfolio is calculated. The active share of each segment may be calculated by summing the absolute values of active weights of each financial object in the segment and dividing by two. For example, if the active weights of a segment are: −0.79%, 0.44%, −1.36%, 2.17%, 0.63%, and −1.09%, then the active share of the segment is (0.79%+0.44%+1.36%+2.17%+0.63%+1.09%)/2=3.24%. The active shares for the other segments of the intermediate portfolio are calculated similarly.

At 422, a required active share level greater than zero is selected. For example, an active share of 50% may be selected. Also, a required segmented active share is calculated based on the required active share level and the segment proportions of interest, e.g., the segments identified above in 412.

At 424, a scaling factor is computed for each segment of the intermediate portfolio based on the required active share level and the intermediate active share of the corresponding segment of the intermediate portfolio. For example, the scaling factor could be calculated by dividing the required active share level by the active share of the segment. Using the examples of 420 and 422 above, the scaling factor could be 50%/3.24%=15.43. However, other methods of computing the scaling factor may be used.

At 426, a scaled portfolio is created using the intermediate active weights and the scaling factors. For example, if financial object A has an intermediate active weight of −0.79% and the scaling factor for the segment including A is 15.43, then a scaled active weight for A is −0.79%*15.43=−12.19%. Then to get the contribution of A in the scaled portfolio, the scaled active weight of A is added to the segmented benchmark for A (26.17%), which equals 13.98%. The rest of the financial objects in the scaled portfolio may be computed similarly.

Further, for each financial object of the scaled portfolio, other factors may apply in computing the contributions of the financial objects to the scaled portfolio. For example, financial constraints may be added to the computation. For instance, a liquidity constraint using whatever criteria are considered suitable may indicate that a maximum contribution for a particular financial object is 1%, or a constraint against short-selling may indicate that a minimum contribution for a particular financial object is zero (i.e., no negative contributions are allowed). Another constraint may be that no foreign financial objects are allowed, so a maximum value for foreign financial objects is zero.

At 428, a segmented final portfolio including the segments of interest is created based on aggregating the scaled portfolio in proportion to the various segments such that the active shares of each segment of the segmented final portfolio are generally equal to the required segmented active shares.

As used herein, “generally equal to” means equal to within a predetermined range of precision. For instance, rounding errors, and the nature of the computations themselves, may not allow a precise, and exact result. As such, the closest reasonable value within the desired precision is sufficient.

Although many of the above examples are simplified for purposes of illustration, practical applications will likely be significantly more complex. For instance, in an illustrative implementation, selecting a current portfolio comprising financial objects may further include selecting more than one current portfolio, where each portfolio of the current portfolios comprising financial objects. In this example, selecting a current benchmark further comprises selecting a current benchmark comprising a subset of the financial objects of a select portfolio of the current portfolios. Also, computing, for each unique financial object of the current portfolio and current benchmark, an active weight of the corresponding financial object, further includes computing, for each unique financial object of the current portfolios and current benchmark, an active weight of the corresponding financial object for each portfolio of the current portfolios.

Moreover, deriving, for each unique financial object of the current portfolio and current benchmark, a current aggregate active weight further includes deriving, for each unique financial object of the current portfolios and current benchmark, a current aggregate active weight based on the computed active weights for that financial object. Here, a select portfolio of the current portfolios can include at least one financial object not included in another portfolio of the current portfolios. Moreover, in this example, deriving, for each unique financial object of the current portfolio and current benchmark, a current aggregate active weight based on the computed active weights for that financial object may further include averaging, for each unique financial object of the current portfolio and current benchmark, the computed active weights for that financial object over all of the current portfolios.

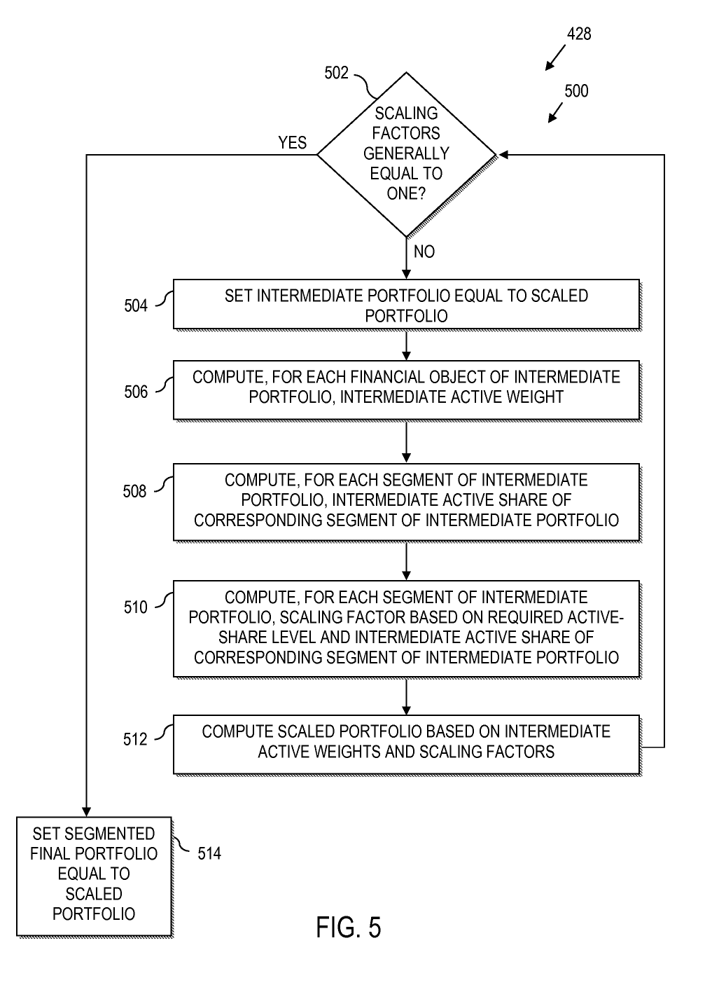

Turning now to FIG. 5, a method 500 of creating the segmented final portfolio is shown. Referring again briefly to FIG. 1, software application 140 is executed by the processor 110 in order to carry out a program flow 500 stored in memory 120, as shown in FIG. 5.

At 502 a decision is made as to whether the scaling factors of each of the segments of the scaled portfolio are generally equal to one. If the scaling factors are not all generally equal to one, then the method 500 proceeds to 504. Other decisions may indicate the same results as the decision of 502. For example, the decision can be whether all of the active shares of the scaled portfolio are generally equal to the required active share level.

At 504, the intermediate portfolio is set equal to the scaled portfolio. Then, a process occurs that is similar to 418, 420, 424, and 426, at 506, 508, 510, and 512 respectively. Thus, at 506, intermediate active weights are computed for each financial object of the intermediate portfolio, similar to 418. At 508, an active share of each segment of the intermediate portfolio is calculated similar to 420. At 510, a scaling factor is computed for each segment of the intermediate portfolio based on the required active share level and the active share of the corresponding segment of the intermediate portfolio, similar to 424. At 512, a scaled portfolio is created using the intermediate active weights and the scaling factors, similar to 426 (including the optional constraints).

This process iterates (including 504) until the decision at 502 yields a YES, and at 514, the segmented final portfolio is set equal to the scaled portfolio. At this point the segmented final portfolio has the required segmented active share.

Aspects of the present disclosure provide approaches for selecting and weighting financial objects, (e.g. financial instruments and/or securities, and more broadly any sort of investment) for an index and portfolio with defined active share level. Such approaches may be utilized for measuring the performance and characteristics of the index portfolio, and for investing in instruments and/or structures based on such index and portfolio.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system. Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, a portable compact disc read-only memory (CD-ROM), a magnetic storage device, or any suitable combination of the foregoing. In the context of this document, a computer readable storage medium may be any tangible medium that can contain, or store a program for use by or in connection with an instruction execution system, apparatus, or device. Computer-readable storage media do not include signals.

A computer readable signal medium is a propagated data signal with computer readable program code embodied therein, for example, in baseband or as part of a carrier wave.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
selecting a current portfolio comprising financial objects;
selecting a current benchmark comprising a subset of the financial objects of the current portfolio;
computing, for each unique financial object of the current portfolio and current benchmark, an active weight of the corresponding financial object, wherein the active weight indicates how much the corresponding financial object differs in contributing to the current portfolio, and in contributing to the current benchmark;
deriving, for each unique financial object of the current portfolio and current benchmark, a current aggregate active weight based on the computed active weight;
selecting a primary benchmark including financial objects;
identifying segments of interest including a number of segments of interest;
computing a segmented benchmark based on the segments of interest and the primary benchmark, wherein the segmented benchmark comprises segments;
computing an intermediate portfolio based on the segmented benchmark and the current aggregate active weight, wherein the intermediate portfolio comprises segments of the financial objects of the current aggregate active weight;
computing, for each financial object of the intermediate portfolio, an intermediate active weight;
computing, for each segment of the intermediate portfolio, an active share of the corresponding segment of the intermediate portfolio;
selecting a required active share level and computing a required segmented active share based on the required active share level and the segments of interest;
computing, for each segment of the intermediate portfolio, a scaling factor based on the required active share level and the intermediate active share of the corresponding segment of the intermediate portfolio;
computing a scaled portfolio based on the intermediate active weights and the scaling factors; and
creating a segmented final portfolio including segments, wherein the segmented final portfolio is based on the scaled portfolio such that an active share of each of the segments of the segmented final portfolio is generally equal to the required segmented active share for that segment.

2. The method of claim 1, wherein creating a segmented final portfolio further includes:
performing until each of the scaling factors is generally equal to one:
setting the intermediate portfolio equal to the scaled portfolio;
computing, for each financial object of the intermediate portfolio, an intermediate active weight;
computing, for each segment of the intermediate portfolio, an intermediate active share of the corresponding segment of the intermediate portfolio;
computing, for each segment of the intermediate portfolio, a scaling factor based on the required segmented active share and the intermediate active share of the corresponding segment of the intermediate portfolio; and
computing a scaled portfolio based on the intermediate portfolio and the scaling factors; and
setting the segmented final portfolio to the scaled portfolio.

3. The method of claim 1, wherein selecting a current benchmark includes selecting a current benchmark comprising an entirety of the financial objects of the current portfolio.

4. The method of claim 1, wherein selecting a current benchmark includes selecting a current benchmark that includes at least one financial object not included in of the current portfolio.

5. The method of claim 1, wherein computing, for each financial object, an active weight of the corresponding financial object further includes computing, for each financial object, an active weight of the corresponding financial object by subtracting a contribution of the financial object to the current benchmark from a contribution of the financial object to the current portfolio.

6. The method of claim 1, wherein selecting a primary benchmark includes selecting the current benchmark as the primary benchmark.

7. The method of claim 1, wherein selecting a primary benchmark includes selecting a benchmark independent of the current benchmark as the primary benchmark.

8. The method of claim 1, wherein identifying segments of interest including a number of segments of interest further includes associating subsets of the financial objects within the primary benchmark with each of the segments of interest.

9. The method of claim 1, wherein computing a segmented benchmark includes:
segmenting the primary benchmark into a number of segments equal to the number of segments of interest based on the segments of interest; and
computing, for each financial object within the primary benchmark, a segmented benchmark value by dividing a value of the corresponding financial object of the primary benchmark by a sum of the values of all the values of the financial objects within the segment of the primary benchmark in which the corresponding financial object is located.

10. The method of claim 9, computing an intermediate portfolio includes:
segmenting the intermediate portfolio into a number of segments equal to the number of segments of interest based on the segments of interest; and
computing, for each financial object within the intermediate portfolio, a segmented aggregate active weight by dividing a sum of a value of the corresponding financial object of the primary benchmark and a value of the current aggregate active weight of the corresponding financial object by a sum of the values of all the values of the financial objects within the segment of the current benchmark and the current aggregate active weights in which the corresponding financial object is located.

11. The method of claim 1, wherein computing a scaled portfolio is further based on a financial constraint.

12. The method of claim 11, wherein the financial constraint includes a constraint against short-selling.

13. The method of claim 1, wherein:
selecting a current portfolio comprising financial objects further includes selecting more than one current portfolio, each portfolio of the current portfolios comprising financial objects;
selecting a current benchmark further comprises selecting a current benchmark comprising a subset of the financial objects of a select portfolio of the current portfolios;
computing, for each unique financial object of the current portfolio and current benchmark, an active weight of the corresponding financial object further includes computing, for each unique financial object of the current portfolios and current benchmark, an active weight of the corresponding financial object for each portfolio of the current portfolios; and
deriving, for each unique financial object of the current portfolio and current benchmark, a current aggregate active weight further includes deriving, for each unique financial object of the current portfolios and current benchmark, a current aggregate active weight based on the computed active weights for that financial object.

14. The method of claim 13, wherein a select portfolio of the current portfolios includes at least one financial object not included in another portfolio of the current portfolios.

15. The method of claim 13, wherein deriving, for each unique financial object of the current portfolio and current benchmark, a current aggregate active weight based on the computed active weights for that financial object further includes averaging, for each unique financial object of the current portfolio and current benchmark, the computed active weights for that financial object over all of the current portfolios.

16. The method of claim 1, wherein:
identifying segments of interest further includes identifying a large-share segment, a middle-share segment, and a small-share segment.

17. The method of claim 16, wherein selecting a primary benchmark further includes:
ranking financial objects within the primary benchmark based on a percentage that each financial object contributes to the benchmark;
setting a large-share segment by determining a fewest number of financial objects required that, when summed, contribute approximately one-third of the primary benchmark;
setting a middle-share segment by determining a fewest number of financial objects, excluding the financial objects used for the setting the large-share segment, required that, when summed, contribute approximately one-third of the primary benchmark; and
setting a small-share segment by using the financial objects not used in setting the large-share segment and the objects not used in setting the middle-share segment.

18. The method of claim 1, wherein:
identifying segments of interest further includes identifying a large-cap segment, a mid-cap segment, and a small-cap segment.

19. The method of claim 1, wherein:
identifying segments of interest further includes identifying segments of interest based on industry segment.
